(19) United States
(12) Patent Application Publication
(10) Pub. No.: US 2007/0213884 A1
(43) Pub. Date: Sep. 13, 2007

(54) Method of implementing PC game auto-play in vehicle applications

(75) Inventors: Robert J. Burnham, Novi, MI (US); Terrence D. Prestel, Livonia, MI (US); Jonathan Weisberg, Bloomfield Hills, MI (US); George J. DeHelian JR., Roseville, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/370,405

(22) Filed: Mar. 8, 2006

(51) Int. Cl. G05D 1/00

(52) U.S. Cl. 701/1

(57) ABSTRACT

The system includes a controller, a portable media reader, and an input device. The controller is in communication with the portable media reader and the input device. The controller detects when a particular portable media is inserted into the portable media reader for a first time. When the controller detects the initial insertion of the portable media, the controller records a macro. As the user configures the system, user input is recorded by the macro. The controller is configured to play the macro when the portable media is subsequently loaded into the portable media player.

### BACKGROUND

1. Field of the Invention

The present invention generally relates to a human machine interface system for a vehicle.

2. Description of Related Art

Entertainment systems in vehicles have become more and more prevalent over the years. Today, many vehicles are offered with a built-in video screen for rear seat entertainment. In addition, for many years, recreational vehicles have included video gaming systems integrated into the vehicle, and more recently integrated closely with the vehicle entertainment system.

As vehicle entertainment systems provide more and more functionality, personal computer (PC) platforms are a natural adaptation to provide additional functionality to vehicle passengers. However, in order for a user to play PC games on a PC based system, the user needs to use a keyboard or pointing device to navigate through a multiple step setup procedure before being able to play the game. However, typical PC systems do not have a human machine interface (HMI) that is effective for use in an automobile environment. If the device has a keyboard and/or pointing device, it may be difficult for the user to initiate the game while utilizing their safety restraint. In addition, pointing devices are difficult to use while driving around curves or on rough road surfaces. Further, multiple user input devices, such as wireless keyboards, pointing devices, and remote controls create storage problems within the vehicle.

In view of the above, it is apparent that there exists a need for an improved human machine interface system for an entertainment system of a vehicle.

### SUMMARY

In satisfying the above need, as well as overcoming the enumerated drawbacks and other limitations of the related art, the present invention provides an improved HMI system for a vehicle.

The system includes a controller, a portable media reader, and an input device. The controller is in communication with the portable media reader and the input device. The controller detects when a particular portable media, such as a game disk, is inserted into the portable media reader for a first time. When the controller detects the initial insertion of the portable media, the controller records a macro. As the user configures the system, user input is recorded by the macro. The user input may include graphical navigation, symbolic navigation, or any system interaction including interaction with the operating system. The controller is configured to play the macro when the portable media is subsequently loaded into the portable media player. The controller may automatically prompt the user whether to play the macro or simply automatically play the macro when the portable media is subsequently loaded into the portable media player. The macro receives the user input and stores the user input according to the sequence it is entered.

During playing of the macro, the controller may be configured to pause between each discrete step allowing the user to override or provide additional input to the operating system during playing of the macro. Further, the input device includes control inputs configured to skip a step in the sequence, skip a pause and continue with the next step, or end the macro and finish the configuration manually. In addition, the controller is configured to detect the mapping of game controller buttons and map game controller buttons based on the macro.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of an HMI system for a vehicle in accordance with one embodiment of the present invention;

FIG. 2 is a flow chart illustrating a method for controlling an HMI system of a vehicle in accordance with one embodiment of the present invention; and

FIG. 3 is a schematic view of a software architecture for the HMI system.

### DETAILED DESCRIPTION

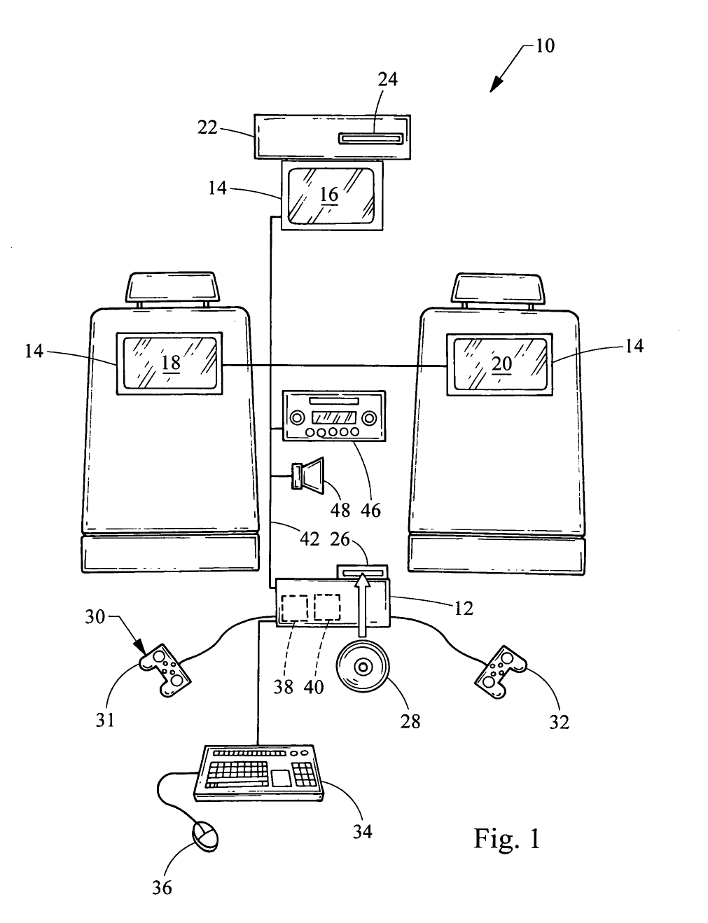

Referring now to FIG. 1, a system embodying the principles of the present invention is illustrated therein and designated at 10. The system 10 includes a controller 12, a portable media reader 26, and an input device 30. The controller 12 being shown as a personal computer. A display 14 being in communication with the controller 12 to display video output. The display may be a flip-down display 16, a seat back display 18, 20, or other commonly known vehicle display. In the case of the flip-down display 16, the display may be integrated with a vehicle entertainment device 22 such as a DVD or VHS player. Such an entertainment device would include a portable media reader 24 that may be used to transfer information to the controller 12. Although, preferably, a portable media reader 26 is located proximate the user and may be integrated with the controller 12. The portable media reader 26 configured to receive portable media 28, shown as a CD or DVD, although other forms of portable media may be used. The controller 12 may include a processor 38 and a fixed media device 40. The processor 38 is configured to execute instructions provided by the portable media player 26 (or 24) to perform typical PC tasks including gaming. The fixed media 40 is in communication with the processor 38 and may include operating system and application initialization information. The fixed media 40 is, preferably, a solid state media such as a static memory although hard disk drives and other common fixed media devices may be used. Using a solid state memory for the fixed media 40 allows a significant reduction in cost and warranty issues with the controller 12. In addition, although the input device 30 is shown as a game controller 31, the input device 30 may comprise a keyboard 34, a mouse 36, or even multiple game controllers such as 31 and 32. Further, the controller 12 may be in communication with other vehicle entertainment devices over a network 42. As such, the vehicle controller 12 may be in communication with an audio system 46 and be configured to adjust audio system parameters including the volume of the audio provided to speaker system 48, as well as, the distribution of sound, for example front-back or left-right.

Accordingly, the controller 12 is configured to record a macro the first time a particular portable media 28 is inserted into the portable media reader 26. Accordingly, the processor 38 checks the disk identifier of the portable media 28 and checks the fixed media 40 to see if a macro is stored corresponding to the disk identifier on the portable media 28. As the user manipulates an input device 30 to configure a program for use, for example a game program for game play, a processor 30 records a macro corresponding to the user navigation. The user navigation may likely include user interaction with the operating system of the controller 12. The macro may be stored as a series of discrete user inputs. Further, the series of discrete user inputs can be stored relative to the sequence they were performed. The series of user inputs may then be replayed in sequence emulating the initial user interaction with the game program. In addition, the user inputs may be based on graphical inputs, such as, a move of a mouse or the move of a cursor based on the game controller 31. The user input may also be based on a symbolic input such as the keyboard 34. For example, as the user selects an icon to start a game, sets the game level, chooses the number of players, selects particular characters, changes the volume, maps game controller buttons, and manipulates other game parameters, the processor 38 detects and stores these series of user inputs onto the fixed media 40. The series of user inputs may be stored in a script file format, such as, a batch or an XML type format. When the user manipulates a predetermined control on the input device 30, the macro recording stops and the macro is cataloged on the fixed media 40. The next time the portable media 28 is inserted into the portable media reader 26, the controller 12 detects that a macro is stored on the fixed media 40 corresponding to that disk identifier and automatically plays the macro or prompts the user if they want the macro played. As the macro plays, the macro may pause between each step in the sequence to receive user input. In addition, the input device 30 may include a predefined control that skips a step when manipulated and another predefined control that ends the macro when manipulated. Accordingly, the user may quickly navigate through the macro skipping certain steps if desired, manipulating the parameters in between macro steps, or ending the macro early to finish configuration manually.

The controller may also include a database of game controllers. As such, the controller may be configured to detect the game controller present and map control inputs of the game controller such as buttons or levers to control inputs on other style game controllers that are supported by the system. As such, during recording of the macro, the macro may also store the game controller type or configuration for later controller input mapping during the subsequent playing of the macro.

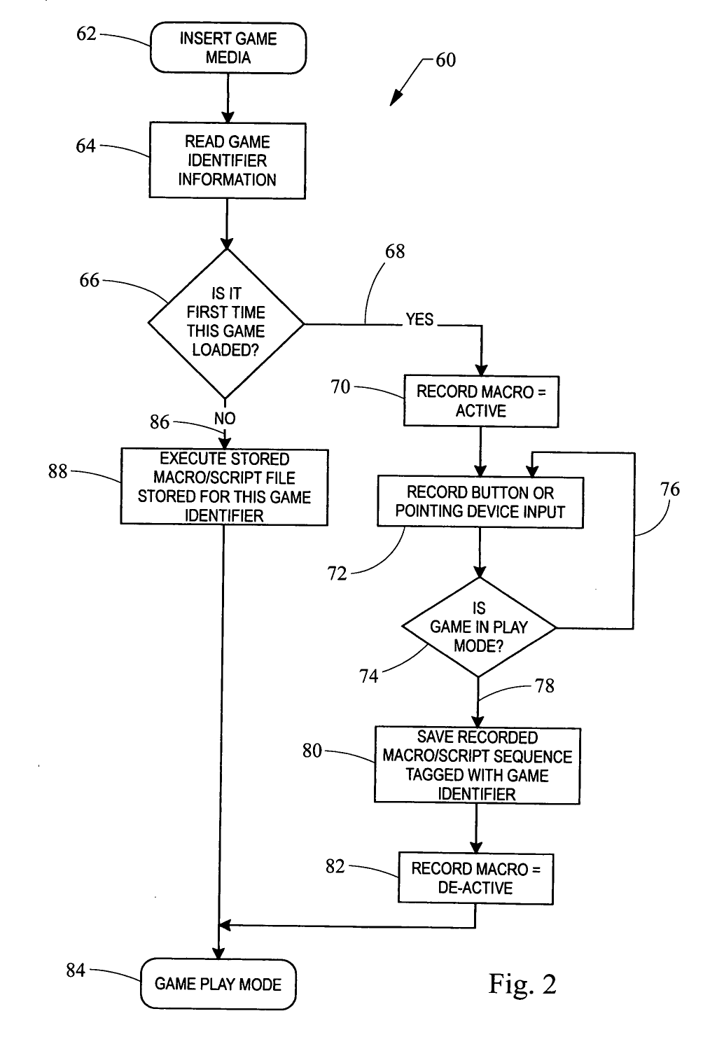

Now referring to FIG. 2, a method 60 is provided to control the HMI for vehicle entertainment system. The method 60 begins when the portable media 28, such as game media, is inserted into the portable media reader 26 as denoted by block 62. In block 64, the system reads game identifier information from the portable media 28. In block 66, the controller 12 determines if it is the first time that game is loaded. If it is the first time the game is loaded, logic follows along line 68 to block 70. In block 70, the macro recording is activated. In block 72, the system receives input from the input device according to the user inputs. As mentioned above, the user input may be provided from a game controller, a mouse, a keyboard, a touch screen device, or other commonly known input devices. In block 74, if the game has not yet entered play mode, the logic loops along line 76 and additional user input is recorded forming a series of user inputs that are recorded in a sequence. When the game does enter play mode as determined by block 74, the logic flows along line 78. In block 80, a recorded macro is saved and the macro is associated with a game identifier, such as the disk identifier. In block 82, the macro is deactivated and the user is allowed to play the game as denoted in block 84.

However, if it is not the first time the game is loaded as determined by block 66, the logic flows along line 86 to block 88. In block 88, the stored macro is played for that game identifier to set the game up into game play mode. As denoted above, the macro may be paused between each step in the sequence allowing user input to change or override the macro settings. In addition, user input may be received to skip a step in the sequence, to skip the pause immediately moving to the next step, or end the macro sequence altogether. If the macro sequence is ended or the macro is completed, the logic flows to block 84 where the user is allowed to play the game and the method ends. The method 60 may be run in a polling mode to identify when new portable media is inserted into the system or an interrupt request may be initiated due to the insertion of the portable media 28 to initiate method 60.

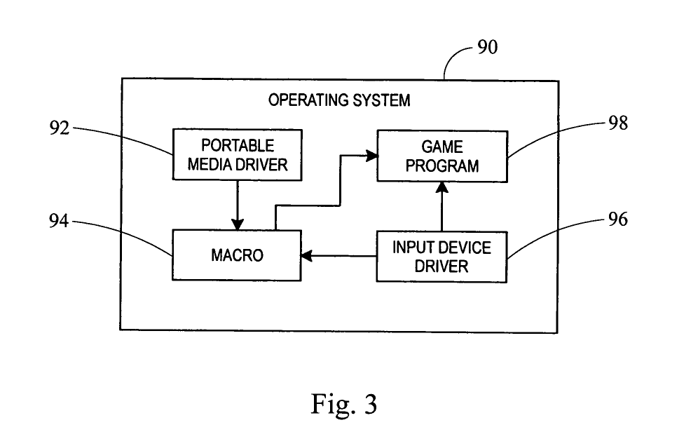

Now referring to FIG. 3, a block diagram of the software interaction and the system is provided. Block 90 represents the operating system which may be a Windows, Linux, DOS, or other commonly available operating system. A portable media driver 92 is provided to run on the operating system 90. The portable media device driver 92 is configured to monitor the status of the portable media device 26, control the portable media device 26, and receive information data from the portable media 28 within the portable media device 26. Information from the portable media driver 92 can be used to initiate, alter, or provide input to the macro 94. In addition, an input device driver 96 is provided to receive input and control the input device 30 which may comprise any of the input devices previously mentioned. The input device driver 96 provides information to the macro 94 indicative of the sequence of user inputs used to configure the game program 96. At the same time the user continues configuring the game program 98, the sequence of steps is recorded within the macro 94 and stored within the controller 12 to be replayed at a subsequent time. In addition, the macro 94 may be in communication with the game program 98 to subsequently replay the macro steps providing the user input to the game program 98 to reproduce the initial setup allowing the user to quickly enter game play mode while the vehicle is in motion.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I/We claim:

1. A system for a vehicle, the system comprising:
a controller;
an input device in communication with the controller to provide user input;
a portable media reader in communication with the controller wherein the controller is configured to record a macro based on an initial insertion of a portable media into the portable media reader and play the macro when the portable media is subsequently loaded into the portable media player.

2. The system according to claim 1, wherein the macro is based on the user input.

3. The system according to claim 1, wherein the macro is based on user graphical navigation.

4. The system according to claim 1, wherein the macro is based on user interaction with the operating system.

5. The system according to claim 1, wherein the macro receives discrete user input steps and stores the discrete user input steps according to the sequence the discrete user input steps are entered.

6. The system according to claim 1, wherein the input device is a game controller.

7. The system according to claim 1, wherein the input device includes a control input configured to end recording of the macro.

8. The system according to claim 1, wherein the input device includes a control input configured to skip a step in the sequence.

9. The system according to claim 1, wherein the controller is configured to map game controller buttons based on the macro.

10. The system according to claim 1, wherein the controller is configured to automatically prompt the user if the macro is to be played.

11. The system according to claim 1, wherein the controller is configured to play the macro automatically.

12. The system according to claim 1, wherein the controller is configured to pause between discrete steps of the sequence thereby allowing for user input.

13. The system according to claim 1, wherein the controller is configured to end a pause in the macro based on a control input of the input device.

14. A method for controlling a human machine interface system, the method comprising the steps of:
receiving a media for an initial insertion;
recording a macro upon receiving the media for the initial insertion;
detecting a subsequent loading of the media; and
playing the macro upon detecting a subsequent loading of the media.

15. The method according to claim 14, wherein the step of receiving a macro includes receiving discrete user input steps and storing the discrete user input steps according to the sequence the discrete user input steps are entered.

16. The method according to claim 15, further comprising the step of pausing between each discrete user input step in the sequence while the macro is played.

17. The system according to claim 16, further comprising the step of skipping a step in the sequence upon receiving a control input.

18. The system according to claim 14, further comprising the step of skipping a pause in the macro based on a control input.

19. The system according to claim 14, further comprising the step of prompting if the macro is to be played based on the step of detecting a subsequent loading of the media.

20. The system according to claim 14, wherein the macro is automatically recorded upon receiving the media for the initial insertion.
